(19) United States
(12) Patent Application Publication
(10) Pub. No.: US 2016/0231736 A1
(43) Pub. Date: Aug. 11, 2016

(54) Continuous improvement procedure aimed to signal, monitor and terminate action plans classified as improvable in a production process

(71) Applicant: Raul Olalla, Ciempozuelos (ES)

(72) Inventor: Raul Olalla, Ciempozuelos (ES)

(21) Appl. No.: 14/617,960

(22) Filed: Feb. 10, 2015

(51) Int. Cl. G05B 19/418

(52) U.S. Cl. CPC G05B 19/41875; G05B 2219/32179

(57) ABSTRACT

The object of the invention is a procedure to signal, monitor and close action plans classified as improvable; part of a production process; and the resources for signalling, monitoring and terminating the improvement of industrial production processes, applicable to any industrial procedure involving persons, such as a factory, repair workshop, administrative system or a process in general; and whose resources are constituted by a signalling panel divided into three zones, i.e. “to be improved”, “improving”, and the “improved” zones; associated to the tokens, some keep on the panel and others on the element to be improved; tokens to be writing with the action plans and saved in several boxes prepared for this purpose, to verify the result of actions undertaken at the time.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

INCORPORATION-BY-REFERENCE OF MATERIAL SUBMITTED ON A COMPACT DISC

Not Applicable

### BACKGROUND OF THE INVENTION

1. Technical Field

The field of the invention is that of the industry for the manufacture of ancillary resources for it and, in general, any industry or service involving persons.

2. Description of the Related Art

It is always possible to imagine that production processes involving persons can be improved.

In fact, changes are always being made to improve these processes at all levels.

What the invention proposes is a scientifically-developed method to indicate where an improvement must be made, the type of improvement considered, and the control and monitoring of the whole procedure till the end of the process, so that all the elements of the organisation involved are at all times aware of the state and situation the procedure is in.

The invention also proposes the appropriate resources for implementing this procedure.

The inventor is unaware of any precursor incorporating the components of this invention, nor the benefits of those components.

### BRIEF DESCRIPTION OF THE DRAWINGS

For a better understanding of the invention, a page of plans is attached, showing the following.

FIG. 1

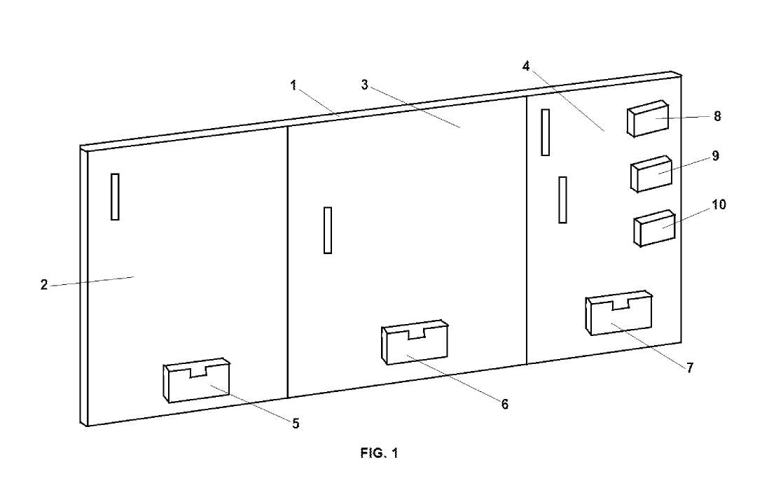

A diagrammatic view of the signalling panel.

FIG. 2

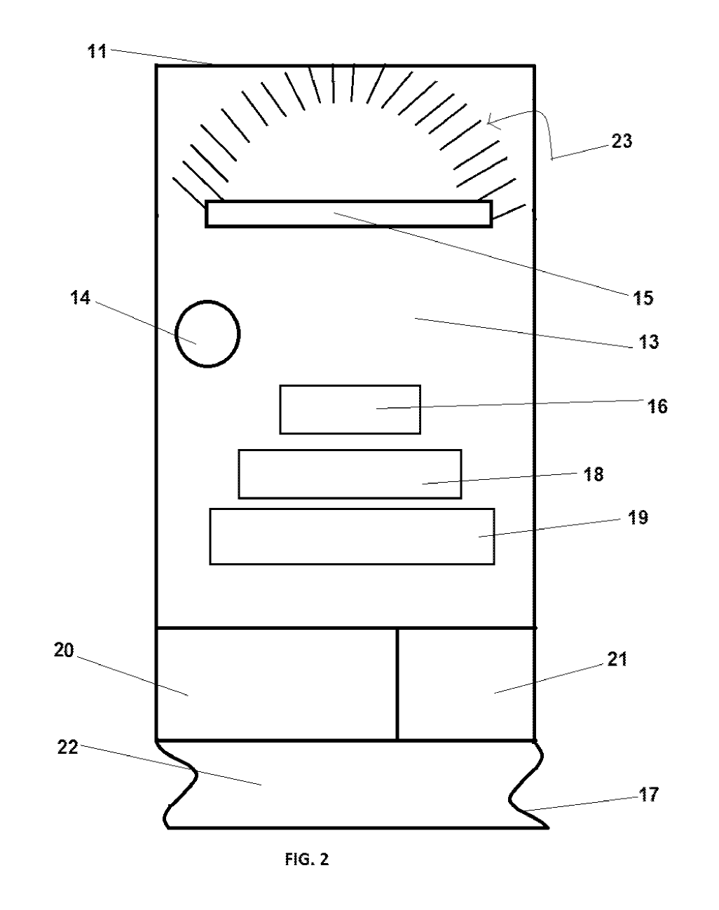

A ground view of the front of a token.

FIG. 3

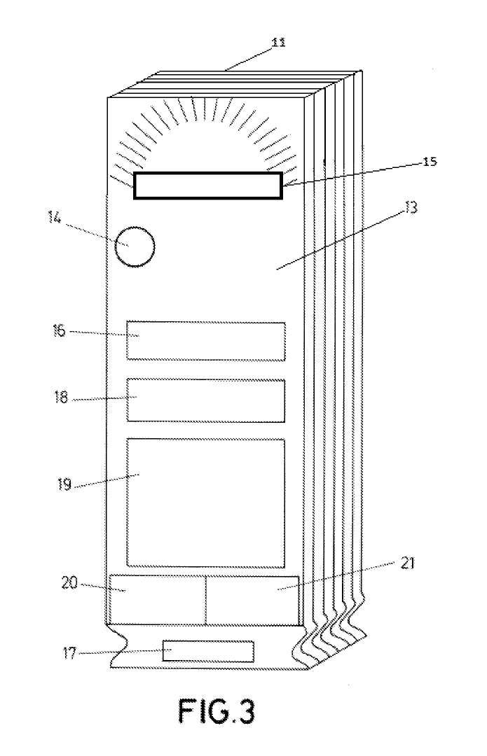

A perspective view of the set of tokens associated with an action

FIG. 4

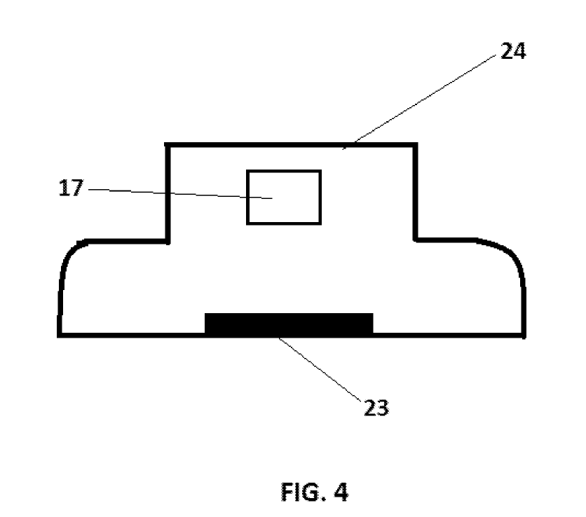

Magnetic/adhesive pyramid

Identical elements are named in said figures, with the same reference, amongst which the following can be distinguished:

(1) signalling panel,

(2) zone one,

(3) zone two,

(4) zone three,

(5) zone one storage box,

(6) zone two storage box,

(7) zone three storage box

(8) monitoring box +4

(9) monitoring box +8

(10) monitoring box +12

(11).-token set

(12) removable rivet,

(13) token

(14) drill-hole,

(15) rectangular horizontal opening

(16) token catalogue frame

(17) area indicating the serial number,

(18) area indicating the date,

(19) area indicating the action plan,

(20) area indicating incidents,

(21) area indicating control,

(22) connecting tab,

(23) area for placing the removable adhesive or the magnetic element,

(24) magnetic/adhesive pyramid

### DETAILED DESCRIPTION OF THE INVENTION

A procedure to signal, monitor and terminate action plans classified as improvable in a production process; and the resources to signal, monitor and close the process for improving industrial production processes, applicable to any industrial procedure involving persons, such as a factory, repair workshop, an administrative system or a process in general, and whose resources comprise at least the following elements:

a signalling panel comprising a rectangular panel of resistant material which may be a metallic blackboard type where it is also possible to write; of soft material, canvas or soft felt to pin tokens and other elements using drawing pins or small nails; flat plastic material for tokens and other elements with self-adhesive surfaces, and divided into three identical, consecutive, rectangular zones differentiated by colour.

The first zone, preferably red, is the zone to be IMPROVED.

The second zone, in the centre of the panel, preferably yellow, is the IMPROVING zone.

The third zone, following from the previous two and so located at the extreme opposite the first zone, preferably green, is the IMPROVED zone.

storage boxes, three in number, in the form of small boxes of transparent material and a parallelepiped straight rectangular shape open at the top, with at least three internal divisions and located at the bottom of each of the three zones, i.e. the storage box in the bottom of the red zone, the storage box in the bottom of the yellow zone and the storage box in the bottom of the green zone.

monitoring boxes, three in number, in the form of small boxes of transparent material and a parallelepiped straight rectangular shape open at the top, with at least three internal divisions and located in the right-hand part of the green zone, in vertical row, and labelled on the outside as follows:

“+4” the box at the top,

“+8” the box located between the two,
“+12” the box located at the bottom.

Signalling tokens in the form of a set of units of 6 tokens, joined by a removable rivet.

3 are labelled ITEM,

One red, one yellow and the other green

3 more labelled BOARD.

One red, one yellow and the other green

Each token comprises a rectangular part made of flexible, resistant material such as plastic-laminated paper.

The tops of the tokens have, at the back, an area provided to carry the attachment element.

Said attachment element may be magnetic, for magnetic panels, adhesive and even both.

The following details may be made out in said tokens:

drill-hole, of diameter slightly greater than that of the removable rivet connecting them.

horizontal rectangular opening,

token catalogue frame in the central top part of the token and marked with the words BOARD or ITEM depending on whether they are for the signalling panel or the element where the improvement action is specified.

Within the tokens, a series of spaces can be made out where it is possible to write, with appropriate resources and largely defined as follows:

area indicating the pre-printed serial number, at the bottom on the connection tab and which is the same for all six tokens.

area indicating the date, setting out the week and year of commencement of the improvement action,

area indicating the action plan, located in the middle and larger than the rest, containing the definition of all the actions to be taken,

area indicating incidents, explaining all the incidents arising

area indicating control, of internal origin and variable depending on the procedures.

There are also tokens of the same shape and characteristics but with all fields blank, and which may be used as substitute tokens while the originals be lost or they deteriorate.

In addition, each token has a connecting tab consisting of offsets on both sides and at the bottom of the token and which can, thanks to the horizontal rectangular opening, be secured to any element for which an improvement is being considered.

In the case of elements where the token cannot be secured in this way, an area is provided with removable adhesive on the upper back of the token, to attach it in this way.

In the case that elements to be improved were metallic, tokens will be used with a magnetic component on the back. If a token cannot be secured using any of these methods to the element for which improvement is to be acted on, provision is made for a pyramid with a magnetic or self-adhesive base which, with the same indications on its sides, has the same role and can be located on the element where the improvement plan is to be applied.

The procedure for the signalling, monitoring and termination of action plans classified as improvable as part of a production process, can applied to any industrial procedure involving persons,

And the following phases can be distinguished:
1 Token Delivery:

To be delivered in units of 6 tokens with the same serial number, connected using the removable rivet and in the three basic colours, to differentiate each of the stages of the improvement.

Thus three token s with the inscription ITEM for the element to be indicated and improved, i.e. one red, one yellow and one green; and three tokens with the inscription BOARD for the signalling panel, one red, one yellow and one green.

The tokens carry a serial number at the bottom, the same for each of the 6 tokens joined using the removable rivet. Thus each improvement plan has the same serial number, guaranteeing that no plan can be lost or not implemented. Each year, a limited number of series can be delivered, thereby ensuring that no plan can be lost.
2 Token Identification:

Once the tokens are in the hands of the person responsible, the spaces on them must be filled in using the same standardised procedure:

area indicating the date, setting out the week and year when the improvement, action in each field began,

area indicating the action plan, located in the middle and larger than the rest, containing as it does the definition of all the actions to be completed, i.e.:

On the red label, the word “IMPROVEMENT”, then a description of the real nature of the problem.

On the yellow label, the phrase “ACTION PLAN” to write the proposed solution.

On the green label, the word “IMPLANTATION”, referring to record of the presence of the solution to the problem.

area indicating incidents, explaining all incidents arising.

area indicating control, internal in origin and variable according to procedures.

On the GREEN labels, both BOARD and ITEM, the monitoring weeks +4, +8 and +12 appear, along with CONTROL, which may contain the signature of the “controller” or the monitor of the solution, or an operator number for example if simpler.

3 Phases

In phase 1, the red label, marked BOARD, goes to the panel, and the red label, named ITEM, goes to the element to be indicated.

The 4 remaining tokens are kept in the storage box located in the red stage.

In phase 2, corresponding to improvement stage 2 (yellow), the phase 1 red labels marked BOARD and ITEM are stored in the storage box in the yellow zone, along with the green tokens of the following process.

The yellow tokens denominated BOARD and ITEM have already been removed from the red storage box and each placed in their positions.

The procedure is the same in phase 3, corresponding to the green improvement stage, so that the green label denominated BOARD will be on the panel, and the green label—ITEM—on the element for improvement.

The storage box, placed in green, stores the 4 tokens already used: two red and two yellow, denominated BOARD and ITEM respectively.

In each of these changes of stage corresponding to each Stage of Improvement, the date of commencement of the improvement is written in the associated zones, with the problem to be Improved, the action for the improvement, and a record of the introduction of the improvement; all on each of the tokens denominated BOARD and ITEM.

In phase 4, corresponding to the green stage, the Improvement is already in place.

In this way, the monitoring box “+4” gathers the green tokens denominated BOARD and ITEM coming from the panel and element respectively indicated; and from the storage box, at the green improvement stage, the remaining tokens of the previous stages.

Thus storage box “+4” will, contain the 6 initial tokens which have already gone through all the stages.

Similarly, the green ITEM token can remain on the element indicated throughout the monitoring process until ending at stage +12, where all tokens (the six) will be collected). phase 5. 4 weeks following the previous step and once confirmed that the improvement introduced continues to operate, all the tokens must be moved to monitoring box “+8”.

Green ITEM can also be monitored on the element indicated after the monitoring is signed.

The entire process ends with the gathering of the 6 tokens corresponding to a single serial number from the “+8” monitoring box to the last monitoring box “+12”, 4 weeks following the previous monitoring process, if it is confirmed that the improvement process is adequately installed and tested.

### Description of the Preferred Embodiment

A procedure for signalling, monitoring and terminating action plans classified as improvable in a production process, and the resources to signal, monitor and close the process for improvement, of industrial production processes, applicable to any industrial procedure involving persons, such as a factory, repair workshop, administrative system or a process in general; and whose resources comprise at least the following elements:

a signalling panel (1) comprising a rectangular panel of resistant material such a metallic blackboard type; and divided into three identical, consecutive, rectangular zones differentiated by colour.

The first zone (2), preferably red, is the zone to be IMPROVED.

The second zone (3), in the centre of the panel (1), preferably yellow, is the IMPROVING zone.

The third zone (4), following from the previous two, and so located at the extreme opposite the first zone (2), preferably green, is the IMPROVED zone.

storage boxes, (5), (6) and (7), in the form of small boxes of transparent material and a parallelepiped straight rectangular shape open at the top, with at least three internal divisions and located at the bottom of each of the three zones, i.e. the storage box (5) in the bottom of the red zone (2), the storage box (6) in the bottom of the yellow zone (3), and the storage box (7) in the bottom of the green zone (4).

monitoring boxes (8), (9) and (10), in the form of small boxes of transparent material and a parallelepiped straight rectangular shape open at the top, with at least three internal divisions and located in the right-hand part of the green zone, in a vertical row, and labelled on the outside as follows:

“+4” the box (8) at the top,

“+8” the box (9) located between the two,
“+12” the box (10) located at the bottom.

Signalling tokens (11), in the form of a set of units of 6 tokens (13), joined by a removable rivet (12).

3 are labelled ITEM,

One red, one yellow and the other green

3 more labelled BOARD.

One red, one yellow and the other green

Each token (13) comprises a rectangular part made of flexible, resistant material such as plastic-laminated paper; where it is possible to write, with appropriate resources.

The top of the tokens (13) have, at the back, a magnetic area (23) provided to carry the attachment element for to be used in metallic boards.

The following details may be made out in said tokens:

(14) drill-hole, of diameter slightly greater than that of the removable rivet (12)

(15) horizontal rectangular opening,

(16) token catalogue frame in the central top part of the token (13) and marked with the words BOARD or ITEM depending on whether they are for the signalling panel (1), or the element where the improvement action is specified.

(17) area indicating the pre-printed serial number, at the bottom, on the connection tab (22), and which is the same for all six tokens (11).

(18).-area indicating the date, setting out the week and year of commencement of the improvement action,

(19) area indicating the action plan, located in the middle and larger than the rest, containing the definition of all the actions to be taken,

(20) area indicating incidents, explaining all the incidents arising,

(21) area indicating control, of internal origin and variable depending on the procedures.

(22) connecting tab, consisting of offsets on both sides and at the bottom of the token (13) and which can, thanks to the horizontal rectangular opening (15), be secured to any element for which an improvement is being considered.

In the case of elements were the token cannot be secured in this way, an area is provided with removable adhesive (23) on the upper back of the token (13), to attach it in this way.

In the case that elements to be improved were metallic, tokens will be used with a magnetic component on the back (23).

If a token cannot be secured using any of these methods to the element for which improvement is to be acted on, provision is made for a pyramid (24) with a magnetic or self-adhesive base which, with the same indications on its sides, has the same role and can be located on the element where the improvement plan is to be applied.

There are also tokens of the same shape and characteristics but with all fields blank, and which may be used as substitute tokens while the originals be lost or they deteriorate.

The procedure for the signalling, monitoring and termination of action plans classified as improvable as part of a production process, can be applied to any industrial procedure involving persons, such as a factory, repair workshop, administrative system or a process in general.

And the following phases can be distinguished:

1 Token Delivery:

To be delivered in units of 6 tokens (11) with the same serial number, connected using the removable rivet (12) and in the three basic colours, to differentiate each of the stages of the improvement.

Thus, three tokens (13) with the inscription ITEM for the element to be indicated and improved, i.e. one red, one yellow and one green; and three tokens (13) with the inscription BOARD for the signalling panel, one red, one yellow and one green.

The tokens carry a pre-printed serial number at the bottom, in the (17) area, and it is the same for each of the 6 tokens joined using the removable rivet (12).

Thus each improvement plan has the same serial number, guaranteeing that no plan can be lost or not implemented.

Each year, a limited number of series can be delivered, thereby ensuring that no plan can be lost.

2 Token Identification:

Once the tokens (11) are in the hands of the person responsible, the spaces on them must be filled in using the same standardised procedure:

area indicating the date (18), setting out the week and year when the improvement action in each field began,

area indicating the action plan (19), located in the middle and larger than the rest, containing as it does the definition of all the actions to be completed, i.e.:

On the red label, the word “IMPROVEMENT”, then description of the real nature of the problem.

On the yellow label, the phrase “ACTION PLAN” to write the proposed solution.

On the green label, the word “IMPLANTATION”, referring to record of the presence of the solution to the problem.

area indicating incidents (20), explaining all incidents arising.

area indicating control (21), internal in origin and variable according to procedures.

On the GREEN labels, both BOARD and ITEM, the monitoring weeks +4 (8), +8 (9) and +12 (10) appear, along with CONTROL, which may contain the signature of the “controller” or the monitor of the solution; or an operator number for example if simpler.

3 Phases

In phase 1, the red label, marked BOARD, goes to the panel in red (2), and the red label, named ITEM, goes to the element be pointed; and thanks to the horizontal rectangular opening (15) and connecting tab (22) at the bottom of the token, be secured to any element for which an improvement is being considered.

In the case of elements where the token cannot be secured in this way, a magnetic area (23) is provided on the upper back of the token, to attach it in this way.

The 4 remaining tokens are kept in the storage box (5) located in the red stage.

In phase 2, corresponding to improvement stage (yellow), the phase 1 red labels marked BOARD and ITEM are stored in the storage box (6) in the yellow zone (3), along with the green tokens of the following process.

The yellow tokens denominated BOARD and ITEM have already been picked up from the red storage box and each placed in their positions.

The procedure is the same in phase 3, corresponding to the green improvement stage, so that the green label denominated BOARD will be on the panel in green (4), and the green label—ITEM—on the element for improvement.

The storage box (7), placed in green, stores the 4 tokens already used: two red and two yellow, denominated BOARD and ITEM respectively.

In each of these changes of stage corresponding to each Stage of Improvement, the date of commencement of the improvement is written in the associated zones (18); in addition to the (19) area, writing the problem to be Improved; the action for the improvement, and a record of the introduction of the improvement; all on each of the tokens denominated BOARD and ITEM.

In phase 4, corresponding to the green stage, the Improvement is already in place.

In this way, 4 weeks following the previous stage in phase 3, the monitoring box “+4” (8) gathers the green tokens denominated BOARD and ITEM coming from the panel and element respectively indicated; and from the storage box (7) at the green improvement stage, the remaining tokens of the previous stages.

Thus storage box “+4” (8) will contain the 6 initial tokens which have already gone through all the stages.

Similarly, the green ITEM token can remain on the element indicated throughout the monitoring process until ending at stage +12 (10), where all tokens (the six) will be collected).

phase 5. 4 weeks following the previous step and once confirmed that the improvement introduced continues to operate, all the tokens must be moved to monitoring box “+8” (9).

Green ITEM can also he monitored on the element indicated after the monitoring is signed.

The entire process ends with the gathering of the 6 tokens corresponding to a single serial number from the “+8” (9) monitoring box to the last. monitoring box “+12” (10), 4 weeks following the previous monitoring process, if it is confirmed that the improvement process is adequately installed and tested.

Adequately described the nature of the invention, as well as the way to practice, should be noted that the previously indicated statements and represented in the accompanying drawings are susceptible to changes of detail so far as they do not modify its fundamental principles, set out in the above paragraphs and summarized in the following claims.

1. A procedure for signalling, monitoring and terminating action plans classified as improvable in a production process, and the resources to signal, monitor and close the process for improvement of industrial production processes, applicable to any industrial procedure involving persons, such as a factory, repair workshop, administrative system or a process in general; and whose resources comprise at least the following elements:
a signalling panel (1) comprising a rectangular panel of resistant material such a metallic blackboard type; and divided into three identical, consecutive, rectangular zones differentiated by colour.
The first zone (2), preferably red, is the zone to be IMPROVED.
The second zone (3), in the centre of the panel (1), preferably yellow, is the IMPROVING zone.
The third zone (4), following from the previous two, and so located at the extreme opposite the first zone (2), preferably green, is the IMPROVED zone.
storage boxes, (5), (6) and (7), in the form of small boxes of transparent material and a parallelepiped straight rectangular shape open at the top, with at least three internal divisions and located at the bottom of each of the three zones, i.e. the storage box (5) in the bottom of the red zone (2), the storage box (6) in the bottom of the yellow zone (3), and the storage box (7) in the bottom of the green zone (4).
monitoring boxes (8) , (9) and (10), in the form of small boxes of transparent material and a parallelepiped straight rectangular shape open at the top, with at least three internal divisions and located in the right-hand part of the green zone, in a vertical row, and labelled on the outside as follows:
“+4” the box (8) at the top,
“+8” the box (9) located between the two,
“+12” the box (10) located at the bottom.
Signalling tokens (11), in the form of a set of units of 6 tokens (13), joined by a removable rivet (12).
3 are labelled ITEM,
One red, one yellow and the other green
3 more labelled BOARD.
One red, one yellow and the other green
Each token (13) comprises a rectangular part made of flexible, resistant material such as plastic-laminated paper; where it is possible to write, with appropriate resources.
The top of the tokens (13) have, at the back, a magnetic area (23) provided to carry the attachment element for to be used in metallic boards.
The following details may be made out in said tokens:
(14) drill-hole, of diameter slightly greater than that of the removable rivet (12)
(15) horizontal rectangular opening,
(16) token catalogue frame in the central top part of the token (13) and marked with the words BOARD or ITEM.
(17) area indicating the pre-printed serial number, at the bottom, on the connection tab (22), and which is the same for all six tokens (11).
(18) area indicating the date,
(19) area indicating the action plan, located in the middle and larger than the rest,
(20) area indicating incidents,
(21) area indicating control,
(22) connecting tab, consisting of offsets on both sides and at the bottom of the token (13) and which can, thanks to the horizontal rectangular opening (15), be secured to any element for which an improvement is being considered. The tokens attached to the to the signalling panel (1) will use a magnetic component (23) on the upper back of the token (13).

2. A procedure for signalling, monitoring and terminating action plans classified as improvable in a production process, and the resources to signal, monitor and close the process for improvement of industrial production processes, applicable to any industrial procedure involving persons; characterized by the procedure of signalling, monitoring and terminating classified as improvable, consists of the following phases:
a Token delivery:
To be delivered in units of 6 tokens (11) with the same serial number, connected using the removable rivet (12) and in the three basic colours. Thus, three tokens (13) with the inscription ITEM for the element to be indicated and improved, i.e. one red, one yellow and one green; and three tokens (13) with the inscription BOARD for the signalling panel, one red, one yellow and one green.
The tokens carry a pre-printed serial number at the bottom, in the (17) area, and it is the same for each of the 6 tokens joined using the removable rivet (12).
b Token identification:
Once the tokens (11) are in the hands of the person responsible, the spaces on them must be filled in using the same standardised procedure:
area indicating the date (18), setting out the week and year when the improvement action in each field began,
area indicating the action plan (19), located in the middle and larger than the rest, containing as it does the definition of all the actions to be completed, i.e.:
On the red label, the word “IMPROVEMENT”, then a description of the real nature of the problem.
On the yellow label, the phrase “ACTION PLAN” to write the proposed solution.
On the green label, the word “IMPLANTATION”, referring to record of the presence of the solution to the problem.
area indicating incidents (20),
area indicating control (21),
On the GREEN labels, both BOARD and ITEM, the monitoring weeks +4 (8), +8 (9) and +12 (10) appear, along with CONTROL, which may contain the signature of the “controller” or the monitor of the solution.
c Phases
In phase 1, the red label, marked BOARD, goes to the panel in red (2), and the red label, named ITEM, goes to the element be pointed; and thanks to the horizontal rectangular opening (15) and connecting tab (22) at the bottom of the token, be secured to any element for which an improvement is being considered.
In the case of elements where the token cannot be secured in this way, a magnetic area (23) is provided on the upper back of the token (13), to attach it in this way.
The 4 remaining tokens are kept in the storage box (5) located in the red stage.
In phase 2, corresponding to improvement stage 2 (yellow), the phase 1 red labels marked BOARD and ITEM are stored in the storage box (6) in the yellow zone (3), along with the green tokens of the following process.
The yellow tokens denominated BOARD and ITEM have already been picked up from the red storage box and each placed in their positions.
The procedure is the same in phase 3, corresponding to the green improvement stage, so that the green label denominated BOARD will be on the panel in green (4), and the green label—ITEM—on the element for improvement.
The storage box (7), placed in green, stores the 4 tokens already used: two red and two yellow, denominated BOARD and ITEM respectively.
In each of these changes of stage corresponding to each Stage of improvement, the date of commencement of the improvement is written in the associated zones (18); in addition to the (19) area, writing the problem to be Improved; the action for the improvement, and a record of the introduction of the improvement; all on each of the tokens denominated BOARD and ITEM.
In phase 4, corresponding to the green stage, the Improvement is already in place.
In this way, 4 weeks following the previous stage in phase 3, the monitoring box “+4” (8) gathers the green tokens denominated BOARD and ITEM coming from the panel and element respectively indicated; and from the storage box (7) at the green improvement stage, the remaining tokens of the previous stages.
Thus storage box “+4” (8) will contain the 6 initial tokens which have already gone through all the stages.
phase 5, 4 weeks following the previous step and once confirmed that the improvement introduced continues to operate, all the tokens must be moved, to monitoring box “+8” (9).
The entire process ends with the gathering of the 6 tokens corresponding to a single serial number from the “+8” (9) monitoring box to the last monitoring box “+12” (10), 4 weeks following the previous monitoring process, if it is confirmed that the improvement process is adequately installed and tested.

3. A procedure for signalling, monitoring and terminating action plans classified as improvable in a production process, and the resources to signal, monitor and close the process for improvement, of industrial production processes, applicable to any industrial procedure involving persons according with according to claim 1, and characterized because in case that the token (13) could not be secured to the element to be improved, either by magnetic method or through the rectangular horizontal, opening matched with the tab (22), a removable adhesive (23) in the upper back area of the token (13) is foreseen.

4. A procedure for signalling, monitoring and terminating action plans classified as improvable in a production process, and the resources to signal, monitor and close the process for improvement of industrial production processes, applicable to any industrial procedure involving persons according to claim 1 and also as seen in claim 3, and characterized because in case the token (13) cannot be attached on the element to be improved in any of the ways described above, a magnetic pyramid (24) has been foreseen, with a magnetic or self-adhesive basis, that with the same indications in his faces than this of the token (13), have the same functions and can be positioned on the element on which the improvement plan is applied.

5. A procedure for signalling, monitoring and terminating action plans classified as improvable in a production process, and the resources to signal, monitor and close the process for improvement of industrial production processes, applicable to any industrial procedure involving persons according to claim 1 and also as seen in claim 3; and characterized because in case the tokens (13) could be lost, or they deteriorate, there are also tokens of the same shape and characteristics but with all fields blank, and which may be used as substitute tokens in case of the originals be lost or they deteriorate.
